(19) United States
(12) Patent Application Publication
(10) Pub. No.: US 2016/0286563 A1
(43) Pub. Date: Sep. 29, 2016

(54) RADIO COMMUNICATION DEVICE AND COMMUNICATION CONTROL METHOD

(71) Applicant: Panasonic Corporation, Osaka (JP)

(72) Inventors: NAGANORI SHIRAKATA, Kanagawa (JP); MASATAKA IRIE, Kanagawa (JP); MASASHI KOBAYASHI, Tokyo (JP); HIROSHI TAKAHASHI, Kanagawa (JP); KOJI TAKINAMI, Kanagawa (JP)

(21) Appl. No.: 15/063,447

(22) Filed: Mar. 7, 2016

(30) Foreign Application Priority Data
Mar. 23, 2015 (JP) 2015-059461

(51) Int. Cl. H04W 72/08; H04L 29/12; H04W 16/28; H04W 72/04

(52) U.S. Cl. CPC H04W 72/082; H04W 72/046; H04L 61/6022; H04W 16/28

(57) ABSTRACT

A radio communication device includes a plurality of directional communicating circuitry which, in operation, each become connected to one or more radio terminals through beam forming and perform radio communication, and space time coordinating circuitry which, in operation, performs controlling of the beam forming of each of the plurality of directional communicating circuitry in accordance with connection information on the connected one or more radio terminals and interference information on interference among the plurality of directional communicating circuitry.

### BACKGROUND

1. Technical Field

The present disclosure relates to a radio communication device that becomes connected to a radio terminal through beam forming (directivity control) and performs radio communication, and a communication control method of the radio communication device.

To enable more radio terminals to be accommodated in or connected to a communication network, it is conventionally performed to arrange many access points (radio base station devices) through a wire network and enlarge a radio communication area all over the network.

A radio terminal can move in a radio communication area while switching an access point as the connection destination. In switching the connection destination (at the time of handover), session information on the radio terminal is transmitted and received between the access points. The transmission and reception of such session information apply loads onto the communication network and thus may be an obstacle to increase the number of terminals to be accommodated or connected.

Techniques for reducing such loads are described in, for example, Japanese Unexamined Patent Application Publication (Translation of PCT Application) No. 2007-527179. According to the techniques described in Japanese Unexamined Patent Application Publication (Translation of PCT Application) No. 2007-527179, which are hereinafter referred to as the “conventional techniques”, in a medium access control (MAC) protocol structure, a MAC layer is separated into a high-level MAC layer for handling session information, and a plurality of low-level MAC layers for controlling a physical layer to perform radio communication. In the conventional techniques, the plurality of low-level MAC layers are arranged as individual access points and header information is used for data transfer between the high-level MAC layer and each low-level MAC layer.

Such conventional techniques can decrease the overhead at the time of handover and the loads onto the communication network and accordingly, more radio terminals can be accommodated in or connected to a communication network.

Radio communication standards that use high-frequency bands (radio-frequency bands) have been under more enhanced review in recent years and in particular, millimeter wave communication, which is high-speed communication needing no license and uses 60-GHz-band radio signals, has attracted attention. Examples of the standards set for the millimeter wave communication include IEEE 802.15.3c, which is a wireless personal area network (PAN) standard, and IEEE 802.11ad, which is a wireless local area network (LAN) standard.

Thus, also as to a communication network for the millimeter wave communication, the accommodation or connection of more radio terminals is desired. In the millimeter wave communication, however, the above-described conventional techniques lack the capability to increase the number of radio terminals to be accommodated or connected. The reasons are described below.

Millimeter-wave-band signals have radio characteristics, which indicate high straightness and large attenuation in space. Accordingly, beam forming techniques, which control the directivity in the radio communication using a plurality of antennas, are employed for the millimeter wave communication. A protocol for the beam forming is specified for each above-described standard too. In regard to the above-described standards, however, specific directivity controlling methods including the selection of the directivity depend on implementation.

That is, in the millimeter wave communication, a radiation pattern of a beam, which is hereinafter referred to as a “beam pattern”, is controlled and the beam width is narrowed to increase the antenna gain and lengthen the distance by which radio waves reach, and the beam is directed so as to follow the position of the radio terminal. When a single access point connects a plurality of radio terminals, the access point performs radio communication with the plurality of radio terminals by time division while switching the beam direction as time elapses.

To perform the handover without disconnection the connection with the communication network of the radio terminals, it is necessary that the access points form beam patterns and the areas where communication is possible, or “cells” as used hereinafter, be brought closer between the plurality of access points. When the cells come closer, however, the beams formed at the same timing come closer and interference is caused, and as a result, the communication quality may be decreased. When no communication is performed between the cells close to each other at the same time so as to avoid such a situation, the number of the radio terminals that can perform communication at the same time is limited and it is thus difficult to increase the communication capacity of the whole communication network.

### SUMMARY

One non-limiting and exemplary embodiment provides a radio communication device and a communication control method, which enable more radio terminals to be accommodated in or connected to a communication network even when the millimeter wave communication is employed.

In one general aspect, the techniques disclosed here feature a radio communication device including: a plurality of directional communicating circuitry which, in operation, each become connected to one or more radio terminals through beam forming and perform radio communication; and space time coordinating circuitry which, in operation, performs controlling of the beam forming of each of the plurality of directional communicating circuitry in accordance with connection information on the connected one or more radio terminals and interference information on interference among the plurality of directional communicating circuitry, wherein the connection information includes information on the connected one or more radio terminals and information on a beam pattern used for communication with the connected one or more radio terminals and is acquired by the space time coordinator, the interference information includes information that, for each of combinations of a plurality of beam patterns among the plurality of directional communicating circuitry, indicates whether or not communication interference occurs in the combination.

According to an aspect of the present disclosure, even when the millimeter wave communication is employed, more radio terminals can be accommodated or connected.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram that illustrates configurations of a radio communication device and a communication system according to an embodiment of the present disclosure as an example;

FIG. 2 is a flow chart that illustrates operation of the radio communication device according to the embodiment as an example;

FIG. 3 illustrates contents of a coordinate table according to the present embodiment as an example; and

FIG. 4 illustrates how distribution of data and scheduling of beam forming according to the embodiment are performed as an example.

### DETAILED DESCRIPTION

An embodiment of the present disclosure is described in detail below with reference to the drawings.

### Configuration of Device

A configuration of a radio communication device 130 according to an embodiment of the present disclosure is described first.

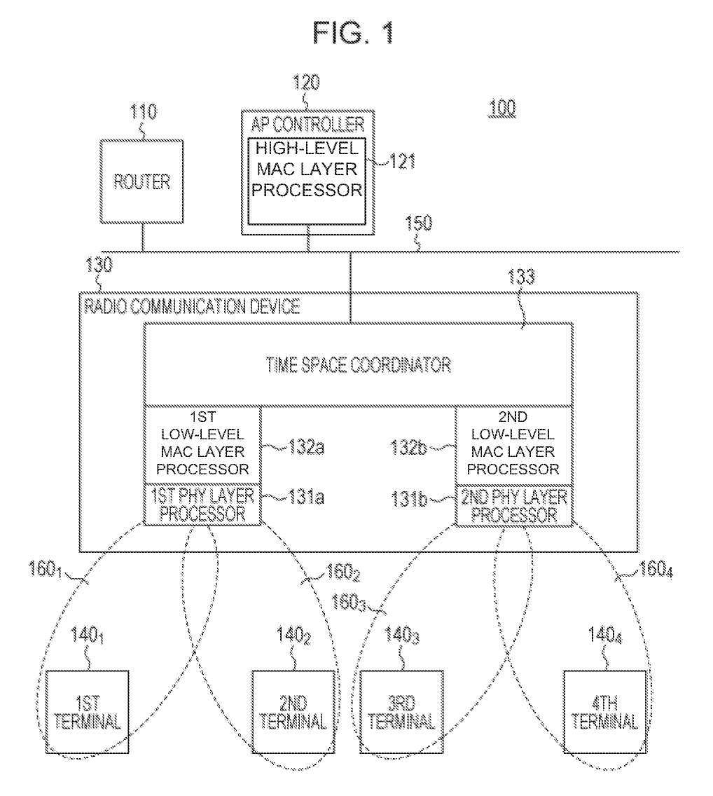

FIG. 1 is a block diagram illustrating a configuration of the radio communication device 130 according to the embodiment and a configuration of a communication system 100 that includes the radio communication device 130 as an example.

In FIG. 1, the communication system 100 includes a router 110, an access point (AP) controller 120, the radio communication device 130, first to fourth terminals (radio terminals) 140₁ to 140₄, and a wired network 150.

Each of the router 110, the AP controller 120, and the radio communication device 130 is connected to the wired network 150. In addition to the radio communication device 130 illustrated in FIG. 1, another radio communication device having a function as an access point is also connected to the wired network 150 although not illustrated. Each of the first to fourth terminals 140₁ to 140₄ is connected to the radio communication device 130 through a millimeter wave wireless network.

Although the radio communication device 130 is herein connected to four terminals, which are the first to fourth terminals 140₁ to 140₄, the number of terminals is not limited to four. That is, the number of the terminals 140 to which the radio communication device 130 is connected may be three or less, or five or more. Given one of the first to fourth terminals 140₁ to 140₄ is referred to as the “terminal 140” when suitable.

The router 110 is connected to an Internet protocol (IP) network, which is hereinafter referred to as an “external network” not illustrated, such as the Internet, and performs data transfer between the wired network 150 and the external network.

The AP controller 120 is connected to the external network via the router 110 and performs data transfer based on IP addresses between the external network and the plurality of access points that include the radio communication device 130. The AP controller 120 includes a high-level MAC layer processor 121.

Although relatively low in speed, the high-level MAC layer processor 121 has functions of performing the connection and authentication of each terminal 140, which are complicated processes, and manages and controls session information on each terminal 140.

On receiving the information on the terminal 140 from which the radio communication device 130 has received a connection request from the radio communication device 130, the high-level MAC layer processor 121 performs the authentication process for the terminal 140 concerned, and associate the terminal 140, which has received the permission for the connection, with the radio communication device 130 and allocates an IP address to the terminal 140. The IP address may be allocated by the router 110.

After that, the high-level MAC layer processor 121 transfers the data that is transmitted from the external network to the first to fourth terminals 140₁ to 140₄ as the destination terminals, to the radio communication device 130. Further, the high-level MAC layer processor 121 transfers the data transmitted from the radio communication device 130 to the destination of the data, which is for example, the external network.

The radio communication device 130 performs multiplexing by space division in addition to time division to perform radio communication with the first to fourth terminals 140₁ to 140₄ and data transfer between the terminals 140 and the high-level MAC layer processor 121. The radio communication device 130 includes a first physical (PHY) layer processor 131a, a second PHY layer processor 131b, a first low-level MAC layer processor 132a, a second low-level MAC layer processor 132b, and a space time coordinator 133.

The first PHY layer processor 131a performs beam forming using an array antenna (not illustrated), where a plurality of antenna elements are arranged. Further, the first PHY layer processor 131a performs millimeter wave communication (millimeter wave wireless transmission) with the first and second terminals 140₁ and 140₂ in accordance with the physical layer format of the IEEE 802.11ad standard for example.

The first PHY layer processor 131a can switch a beam pattern to be formed among a plurality of beam patterns different in beam direction. That is, in the millimeter wave communication where a narrow angle range constitutes a radio signal area, the first PHY layer processor 131a enlarges the communication area (cell) of the first PHY layer processor 131a by sequentially switching the beam direction with the lapse of time.

More specifically, the first PHY layer processor 131a performs predetermined processes, which are coding, modulation, and preamble addition for example, on the transmission data received from the first low-level MAC layer processor 132a and directed to the first and second terminals 140₁ and 140₂. After that, the first PHY layer processor 131a performs frequency conversion on the transmission data that have undergone such processes to obtain 60-GHz-band signals and transmits the resultant signals from the array antenna.

At the time, the first PHY layer processor 131a changes the beam pattern used in the transmission by controlling the amplitude or phase of a signal to be fed to each antenna element in accordance with the beam number designated by the first low-level MAC layer processor 132a, and performs transmission beam forming.

Further, the first PHY layer processor 131a changes the beam pattern at the time of reception by controlling and combining the amplitude or phase of the signal received at each antenna element in accordance with the beam number designated by the first low-level MAC layer processor 132a, and performs reception beam forming. The first PHY layer processor 131a receives the 60-GHz-band signals transmitted from the first and second terminals 140₁ and 140₂ through such reception beam forming.

After that, the first PHY layer processor 131a performs predetermined processes, which are frequency conversion into the base band, filtering, frame synchronization by preamble detection, gain control, demodulation, and decoding for example, on the received signals and outputs the resultant signals to the first low-level MAC layer processor 132a.

The second PHY layer processor 131b has a configuration similar to the configuration of the first PHY layer processor 131a and performs processes similar to the processes that the first PHY layer processor 131a performs for the first low-level MAC layer processor 132a for the second low-level MAC layer processor 132b. The second PHY layer processor 131b is arranged or configured so that the communication area of the second PHY layer processor 131b differs from the communication area of the first PHY layer processor 131a.

That is, space having no mutual overlapping is present between the space occupied by a plurality of beam patterns that the first PHY layer processor 131a can form and the space occupied by a plurality of beam patterns that the second PHY layer processor 131b can form. Accordingly, the communication area of the first and second PHY layer processors 131a and 131b as a whole is larger than the communication area of the first PHY layer processor 131a only or the communication area of the second PHY layer processor 131b only.

In the description below, the first low-level MAC layer processor 132a and the second PHY layer processor 131b are collectively explained as “the low-level MAC layer processor 132” when suitable.

The first low-level MAC layer processor 132a performs the transmission and reception of data with each of the first and second terminals 140₁ and 140₂ using the first PHY layer processor 131a.

That is, the first low-level MAC layer processor 132a performs communication control, which includes access control and packet transmission, for each terminal 140 in accordance with, for example, the MAC protocol of the IEEE 802.11ad standard. The first low-level MAC layer processor 132a performs link connection between the MAC address of the first low-level MAC layer processor 132a and the MAC address of the terminal 140. After that, the first low-level MAC layer processor 132a performs access control using a control frame, such as a beacon, the control of the beam forming training, data frame control, such as data fragmentation or aggregation, retransmission control, and the like for the first PHY layer processor 131a.

More specifically, the first low-level MAC layer processor 132a regularly broadcasts a beacon packet that includes the MAC address of the first low-level MAC layer processor 132a via the first PHY layer processor 131a in accordance with the IEEE 802.11ad protocol.

The terminal 140 that requests to be connected to an access point performs scanning operation on the beacon packet. The terminal 140 that has received the beacon packet of the first low-level MAC layer processor 132a transmits a connection request that includes the MAC address of the terminal 140.

When the first low-level MAC layer processor 132a receives a connection request from any of the terminals 140, first, the first low-level MAC layer processor 132a transmits a request regarding the authentication process for the terminal 140 and the allocation of an IP address to the terminal 140 to the high-level MAC layer processor 121. This request includes the identification information on the terminal 140 included in the connection request from the terminal 140, which is hereinafter referred to as the “terminal identification information”. The terminal identification information is, for example, a MAC header address allocated to each terminal 140 in advance.

After that, when the first low-level MAC layer processor 132a receives the IP address allocated to the terminal 140 from the high-level MAC layer processor 121, the first low-level MAC layer processor 132a performs the beam forming training and determines the beam pattern most suitable for the communication with the terminal 140. After that, the first low-level MAC layer processor 132a outputs the identification information on the determined beam pattern, which is hereinafter referred to as the “beam number”, and the acquired terminal identification information to the space time coordinator 133. The beam forming training is described in detail below.

Consequently, for example, as illustrated in FIG. 1, the first low-level MAC layer processor 132a determines use of a first beam pattern 160₁ for the connection with the first terminal 140₁ and use of a second beam pattern 160₂ for the connection with the second terminal 140₂.

After that, the first low-level MAC layer processor 132a performs the beam forming of the determined beam patterns 160₁ and 160₂ and performs data transfer between the space time coordinator 133 and each of the first and second terminals 140₁ and 140₂.

When the first low-level MAC layer processor 132a receives an instruction regarding the timing (access period) of the beam forming from the space time coordinator 133, the first low-level MAC layer processor 132a performs the beam forming at the timing based on the instruction and performs communication with the terminal 140.

The first low-level MAC layer processor 132a acquires quality information indicating the quality of the communication with each terminal 140 as needed through, for example, the beam forming training, and outputs the acquired quality information to the space time coordinator 133.

In the present embodiment, for each beam pattern, the quality information indicates the reception quality of the radio signal transmitted from each terminal 140, which is obtained at the PHY layer processor 131.

The above-described reception quality includes the reception quality of the radio signal from undesired terminal 140 different from the desired terminal 140 that serves as the communication target of the beam pattern. The reception quality of the radio signal from undesired terminals 140 equals the reception quality of the radio signal that is undesired target of the beam pattern, and means interference information which indicates the amount of the interference from undesired radio signal.

That is, for each terminal 140, the above-described quality information includes the reception quality level of the radio signal from the desired terminal 140 concerned and the reception quality level of the radio signal from undesired terminal 140, which is hereinafter referred to as the “interference level”. As the quality level, for example, the reception signal strength, the signal to noise ratio (SNR), the signal to interference noise ratio (SINR), the reception bit error rate, the reception packet error rate, or the retransmission rate is usable.

Even after the completion of the connection, the first low-level MAC layer processor 132a performs the beam forming training as needed and switches the beam pattern used for the communication with each terminal 140 when suitable. The beam pattern is switched when, for example, the communication quality is decreased by a move of the terminal 140.

When the first low-level MAC layer processor 132a switches the beam pattern used for the communication with each terminal 140, the first low-level MAC layer processor 132a outputs the beam number of the beam pattern after the switching to the space time coordinator 133 together with the terminal identification information on the terminal 140.

The second low-level MAC layer processor 132b has a configuration similar to the configuration of the first low-level MAC layer processor 132a and performs processes similar to the processes that the first low-level MAC layer processor 132a performs for the first PHY layer processor 131a for the second PHY layer processor 131b. For example, as illustrated in FIG. 1, the second low-level MAC layer processor 132b determines use of a third beam pattern 160₃ for the connection with the third terminal 140₃ and determines use of a fourth beam pattern 160₄ for the connection with the fourth terminal 140₄.

That is, the first PHY layer processor 131a and the first low-level MAC layer processor 132a as one unit may be regarded as a first directional communicator that becomes connected to the terminal 140 through the beam forming and performs the radio communication. Similarly, the second PHY layer processor 131b and the second low-level MAC layer processor 132b as one unit may be regarded as a second directional communicator that becomes connected to the terminal 140 through the beam forming and performs the radio communication.

In the description below, the first low-level MAC layer processor 132a and the second low-level MAC layer processor 132b are collectively explained as the “low-level MAC layer processor 132” when suitable.

The space time coordinator 133 is arranged between the first and second low-level MAC layer processors 132a and 132b, and the high-level MAC layer processor 121 and performs data transfer therebetween. The space time coordinator 133 distributes the data transmitted from the high-level MAC layer processor 121 and directed to each terminal 140 to the first and second low-level MAC layer processors 132a and 132b suitably.

More specifically, for each PHY layer processor 131, that is, for each of the above-described directional communicators, the space time coordinator 133 acquires the connection information indicating the terminal 140 to which the PHY layer processor 131 is connected and the beam pattern used for the communication with the terminal 140 concerned. Such connection information includes, for example, the terminal identification information, the beam number, and the IP address, which are described above. Further, in accordance with the acquired connection information, the space time coordinator 133 performs data transfer between the high-level MAC layer processor 121 and each of the first and second low-level MAC layer processors 132a and 132b.

For each combination of a plurality of beam patterns between the first PHY layer processor 131a and the second PHY layer processor 131b, the space time coordinator 133 acquires the interference information that indicates whether or not communication interference occurs in the combination. As described above, the interference information is included in the quality information input from the low-level MAC layer processor 132 and specifically, is the above-described interference level.

In the present embodiment, that “interference occurs” indicates that the level of the interference of a signal interferes with the maintenance of the predetermined communication quality. In contrast, that “no interference occurs” indicates that no interference of a signal is occurring or that although interference of a signal is occurring, the interference level allows the predetermined communication quality to be maintained.

After that, the space time coordinator 133 performs the scheduling of the beam forming for the first PHY layer processor 131a and the second PHY layer processor 131b in accordance with the acquired connection information and interference information.

More specifically, the space time coordinator 133 determines whether or not a combination of the plurality of beam patterns where communication interference occurs is present between the first and second low-level MAC layer processors 132a and 132b, that is, between the first and second PHY layer processors 131a and 131b.

After that, the space time coordinator 133 causes the first and second low-level MAC layer processors 132a and 132b to form a plurality of beam patterns that originate no interference at the same time and causes a plurality of beam patterns that originate interference not to be formed at the same time. Such processes are performed by, for example, the space time coordinator 133 providing instructions regarding the timings to form the beam patterns used for the communication with the respective terminals 140 to the first and second low-level MAC layer processors 132a and 132b.

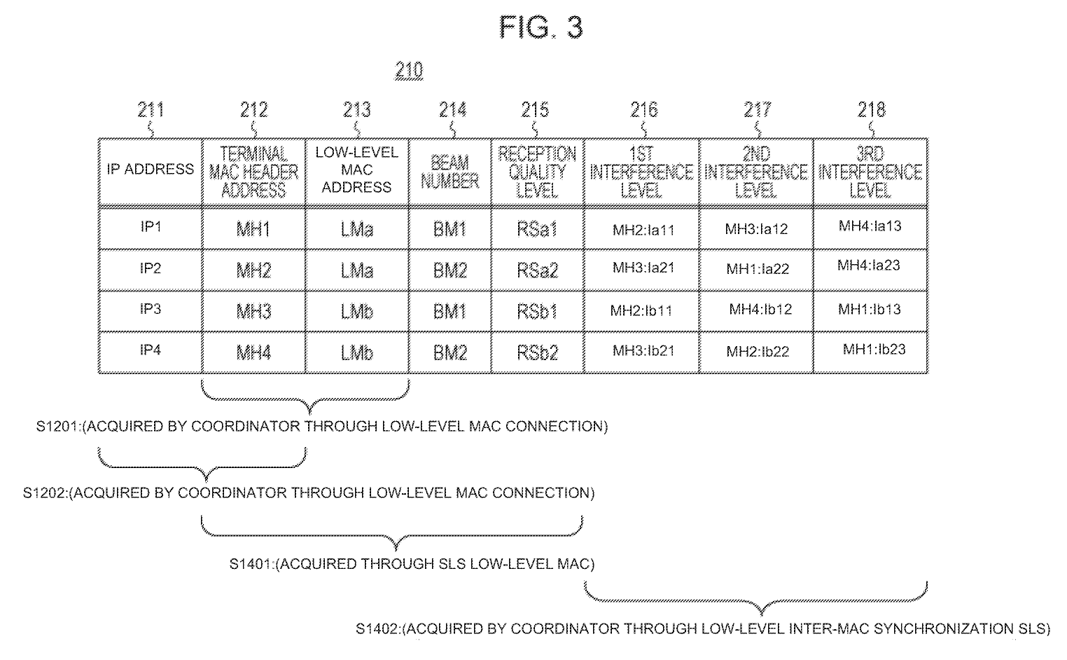

In accordance with the information input from the high-level MAC layer processor 121, the first low-level MAC layer processor 132a, and the second low-level MAC layer processor 132b, the space time coordinator 133 generates and updates a coordinate table 210 (see FIG. 3), which is described below. After that, the space time coordinator 133 performs the scheduling of the beam forming for the first and second PHY layer processors 131a and 131b in accordance with the coordinate table 210.

That is, the space time coordinator 133 manages the information for the beam forming training of the first and second low-level MAC layer processors 132a and 132b using the coordinate table 210. Further, the space time coordinator 133 grasps the reception quality level of a radio signal from each terminal 140 and the levels of the interference between the low-level MAC layer processors 132 and the interference among the terminals 140, and in accordance with these levels, determines a combination of the terminals 140, which enables simultaneous communication.

Each of the first and second terminals 140₁ and 140₂ transmits a connection request on reception of the above-described beacon packet and performs the above-described beam forming training with the first PHY layer processor 131a that has received the connection request. The first and second terminals 140₁ and 140₂ determine the beam patterns most suitable for the communication with the first PHY layer processor 131a, which are not illustrated, through the training described above.

After that, each of the first and second terminals 140₁ and 140₂ performs the beam forming based on the determined beam pattern, and for example, in accordance with the physical layer format of the IEEE 802.11ad standard, performs the millimeter wave communication with the first PHY layer processor 131a.

Each of the third and fourth the terminals 140₃ and 140₄ performs processes similar to the processes of the first and second terminals 140₁ and 140₂ with the second PHY layer processor 131b and performs the millimeter wave communication.

For example, the radio communication device 130 and the other devices each include a central processing unit (CPU), a storage medium storing a control program, such as read only memory (ROM), working memory, such as random access memory (RAM), and a communication circuit, which are not illustrated. In this case, each of the functions of the above-described constituents is implemented by the CPU executing the control program.

The radio communication device 130 configured as described above can perform the scheduling of the beam forming in accordance with what beam pattern is used for the communication with each terminal 140 and which combination of the beam patterns causes communication interference. Further, the radio communication device 130 can perform the above-described scheduling so that, between the first and second PHY layer processors 131a and 131b different in communication area, a plurality of beam patterns that cause no interference are formed at the same time and a plurality of beam patterns that cause interference are not formed at the same time.

Thus, the radio communication device 130 can perform the radio communication between the communication area of the first PHY layer processor 131a and the communication area of the second PHY layer processor 131b at the same time.

The radio communication device 130 includes the space time coordinator 133, which is arranged between the high-level MAC layer processor 121, and the first and second low-level MAC layer processors 132a and 132b and performs data transfer (distribution) therebetween. Accordingly, it is unnecessary for the radio communication device 130 to move the session information even when the handover of the terminal 140 occurs between the communication area of the first PHY layer processor 131a and the communication area of the second PHY layer processor 131b.

Thus, the communication system 100 enables accommodation or connection of more terminals, 140, regardless of employing the millimeter wave communication.

### Regarding Beam Forming Training

The beam forming training is described below.

For example, the low-level beam forming training MAC layer processor 132 performs the beam forming training based on sector level sweep (SLS) of the IEEE 802.11ad protocol. That is, first, the low-level MAC layer processor 132 performs transmission and reception of a training packet with each terminal 140 in each beam pattern while switching the beam pattern. After that, the low-level MAC layer processor 132 performs mutual feedback with each terminal 140 in regard to the beam pattern that indicates the highest reception quality and determines the beam pattern used for the communication with the terminal 140 concerned.

In such beam forming training, for each beam pattern, the reception quality of a radio signal from the terminal 140 for which the beam pattern is not used in the communication is also acquired. Thus, the low-level MAC layer processor 132 can acquire the quality information, which includes the above-described interference information, by, for example, performing the beam forming training.

Each low-level MAC layer processor 132 may distinguish or may not distinguish the beam forming training for determining or switching the beam pattern used for the communication with the terminal 140, which is hereinafter referred to as the “SLS at the time of connection” when suitable, from the beam forming training for acquiring the interference information, which is hereinafter referred to as the “inter-MAC synchronized SLS” when suitable. When the SLS at the time of connection and the inter-MAC synchronized SLS are distinguished from each other, each low-level MAC layer processor 132 performs the inter-MAC synchronized SLS on reception of an instruction from the space time coordinator 133 for example.

The space time coordinator 133 desirably synchronizes periodic executions of the SLS at the time of connection or the inter-MAC synchronized SLS between the first low-level MAC layer processor 132a and the second low-level MAC layer processor 132b. Accordingly, the space time coordinator 133 can acquire the quality information with high efficiency.

Each low-level MAC layer processor 132 may acquire the quality information without depending on the inter-MAC synchronized SLS and output the acquired quality information to the space time coordinator 133. In this case, for example, in a non-signal period included in the period of the communication with the terminal 140 connected, the low-level MAC layer processor 132 receives signals transmitted from another low-level MAC layer processor 132 and the terminal 140 connected to this (another) low-level MAC layer processor 132, and measures the reception qualities thereof.

### Operation of Device

The operation of the radio communication device 130 is described below. The first PHY layer processor 131a, the second PHY layer processor 131b, the first low-level MAC layer processor 132a, and the second low-level MAC layer processor 132b are basically the same as those according to the conventional techniques, except that each of the processors 131a, 131b, 132a, and 132b operates in accordance with an instruction from the space time coordinator 133. Therefore, the operation of the space time coordinator 133 is mainly described.

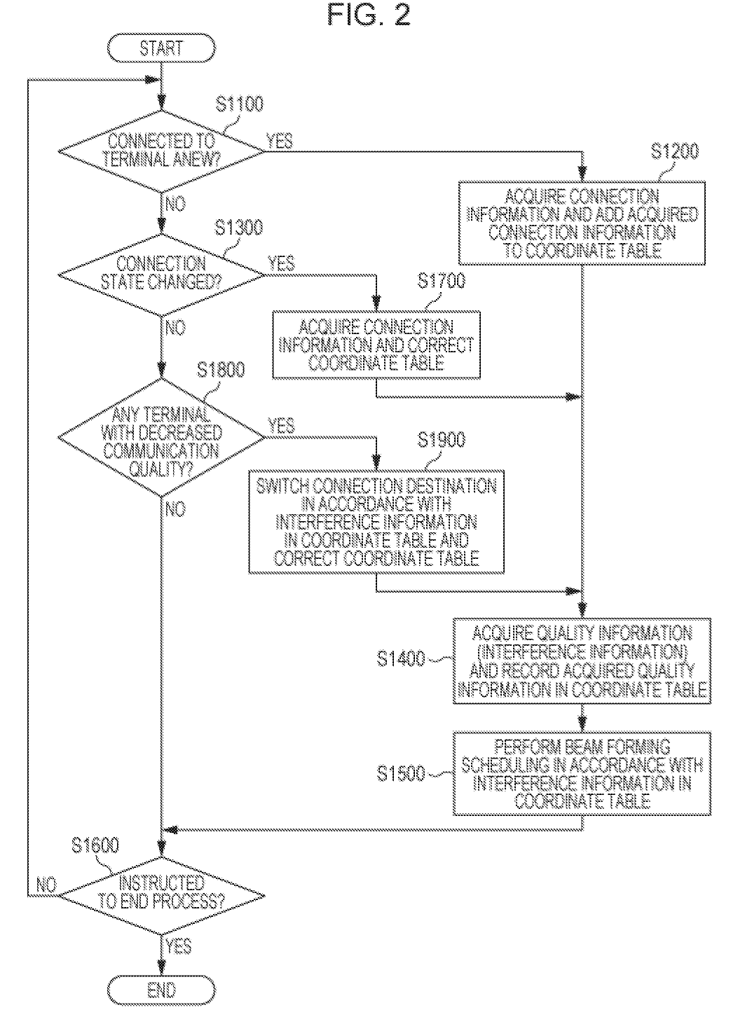

FIG. 2 is a flow chart that illustrates the operation of the radio communication device 130 as an example.

In S1100, the space time coordinator 133 determines whether or not the radio communication device 130 is connected to the terminal 140 anew. The space time coordinator 133 performs such determination in accordance with, for example, whether or not the terminal identification information, the beam number, and the corresponding IP address that are not present in the coordinate table are input.

The space time coordinator 133 acquires such information in transferring an IP address allocation request from the low-level MAC layer processor 132 and in transferring a response for notifying the IP address from the high-level MAC layer processor 121.

When the space time coordinator 133 is connected to the terminal 140 anew (YES in S1100), the space time coordinator 133 advances the process to S1200. When the space time coordinator 133 is not connected to the terminal 140 anew (NO in S1100), the space time coordinator 133 advances the process to S1300, which is described below.

In S1200, through the SLS at the time of connection, which is performed by the low-level MAC layer processor 132, the space time coordinator 133 acquires the identification information on the low-level MAC layer processor concerned, the terminal identification information, the beam number, and the IP information as the connection information on the connected terminal 140. The identification information on the low-level MAC layer processor is, for example, a low-level MAC address. After that, the space time coordinator 133 adds the acquired connection information to the coordinate table 210 (see FIG. 3).

In S1400, the space time coordinator 133 acquires the quality information from the low-level MAC layer processor 132 and records the acquired quality information in the coordinate table 210 (see FIG. 3). As described above, for each terminal 140, that is, for each beam pattern, the quality information indicates the reception quality level of a radio signal from the terminal 140 concerned and the interference level of a radio signal from another terminal 140.

As described above, the space time coordinator 133 may acquire the quality information through the SLS at the time of connection or may acquire the quality information by causing the low-level MAC layer processor 132 to perform the inter-MAC synchronized SLS extra.

FIG. 3 illustrates the contents of the coordinate table as an example. Exemplified in FIG. 3 is a state obtained when sufficient time elapses after the first to fourth terminals 140₁ to 140₄ have become connected to the AP controller 120.

As illustrated in FIG. 3, for example, for each terminal 140, the coordinate table 210 is descriptive of an IP address 211, a terminal MAC header address 212, a low-level MAC address 213, a beam number 214, a reception quality level 215, a first interference level 216, a second interference level 217, and a third interference level 218.

For example, when the low-level MAC layer processor 132 receives a connection request from the terminal 140, the terminal MAC header address of the terminal 140 concerned is input from the low-level MAC layer processor 132 to the space time coordinator 133. After that, the space time coordinator 133 creates entries descriptive of the low-level MAC address, LMa or LMb, and the terminal MAC header address concerned, MH1, MH2, MH3, or MH4, which are input, as the low-level MAC address 213 and the terminal MAC header address 212 in the coordinate table 210 (S1201).

When the high-level MAC layer processor 121 allocates an IP address to the terminal 140, the allocated IP address is input from the high-level MAC layer processor 121 to the space time coordinator 133 together with the terminal MAC header address of the terminal 140 concerned. After that, the space time coordinator 133 causes the input IP address, IP1, IP2, IP3, or IP4, to be described as the IP address 211 of the entry corresponding to the input terminal MAC header address (S1202).

After that, when the low-level MAC layer processor 132 performs the SLS at the time of connection, for each terminal 140, the beam number of the determined beam pattern and the reception quality level of a radio signal from the terminal 140 concerned are input from the low-level MAC layer processor 132 to the space time coordinator 133. After that, the space time coordinator 133 causes the input beam number, BM1 or BM2, and the input reception quality level to be described as the beam number 214 and the reception quality level 215 of the corresponding entry (S1401).

Further, when the low-level MAC layer processor 132 performs the inter-MAC synchronization SLS, for each terminal 140, the interference levels of radio signals from the terminals 140 other than the terminal 140 concerned are input from the low-level MAC layer processor 132 to the space time coordinator 133. After that, the space time coordinator 133 causes the input interference levels to be described as the first to third interference levels 216 to 218 of the corresponding entries in the order from the highest interference level while information indicating the terminals 140 from which the radio signals that cause the interference are transmitted, such as the terminal MAC header addresses MH1 to MH4, is supplied (S1402).

The coordinate table 210 generated as described above includes the contents descriptive of, for each terminal 140, the low-level MAC layer processor 132 to which the terminal 140 concerned is connected and the beam pattern thereof, the communication quality of the terminal 140 concerned, and the interference level caused by another communication.

The coordinate table 210 may be descriptive of the interference information on all of the plurality of beam patterns that each PHY layer processor 131 can form.

In S1500 in FIG. 2, the space time coordinator 133 performs the scheduling of the beam forming for the first and second PHY layer processors 131a and 131b in accordance with the interference information, that is, the first to third interference levels 216 to 218 in the coordinate table 210.

More specifically, for example, the space time coordinator 133 determines whether or not any of the first to third interference levels 216 to 218 whose ratio to the reception quality level 215 is equal to or more than a predetermined threshold is present in the coordinate table 210.

When the interference level ratio to the reception quality level 215 of any of the terminals 140 is equal to or more than the predetermined threshold, the space time coordinator 133 determines the beam pattern used for the terminal 140 concerned and the beam pattern used for another terminal 140 that has transmitted the radio signal of the interference level concerned as constituting a combination that causes communication interference.

When the interference level ratio to the reception quality level 215 of any of the terminals 140 is less than the predetermined threshold, the space time coordinator 133 determines the beam pattern used for the terminal 140 concerned and the beam pattern used for another terminal 140 that has transmitted the radio signal of the interference level concerned as constituting a combination that causes no communication interference.

For example, it is assumed that in the second beam pattern 160₂ directed to the second terminal 140₂, the radio signal transmitted from the third terminal 140₃ is received with relatively high reception strength, and the ratio of an interference level MH3:Ia21 to a reception quality level RSa2 is equal to or more than the predetermined threshold.

In this case, the space time coordinator 133 determines the second beam pattern 160₂ used for the communication with the second terminal 140₂ and the third beam pattern 160₃ used for the communication with the third terminal 140₃ as constituting a combination that causes communication interference.

In contrast, for example, it is assumed that in the first beam pattern 160₁ directed to the first terminal 140₁, the reception strengths of the radio signals from all the other terminals 140 are low, and all of the interference level ratios to a reception quality level RSa1 are less than the predetermined threshold.

In this case, the space time coordinator 133 determines the first beam pattern 160₁ as causing no communication interference with any of the other beam patterns 160.

After that, the space time coordinator 133 causes beam patterns of a combination that causes no communication interference to be formed at the same time, and causes beam patterns of a combination that causes communication interference not to be formed at the same time. That is, in a range where no communication interference occurs, the space time coordinator 133 causes two beam patterns to be formed between the first PHY layer processor 131a and the second PHY layer processor 131b at the same time, and multiplexes the radio communication by space division.

When sufficient throughput of the communication with each terminal 140 is ensured, it is not necessarily desired that the space time coordinator 133 form beam patterns of a combination that causes no communication interference at the same time.

In S1600, the space time coordinator 133 determines whether or not a user operation or the like instructs the process to end. When no instruction to end the process is provided (NO in S1600), the space time coordinator 133 returns the process to S1100.

In S1300, the space time coordinator 133 determines whether or not the connection state of the terminal 140 with respect to the radio communication device 130 is changed. The space time coordinator 133 performs such determination by, for example, determining whether or not a beam number is input from the low-level MAC layer processor 132 together with the terminal identification information present in the coordinate table 210 (see FIG. 3).

When the connection state of the terminal 140 is changed (YES in S1300), the space time coordinator 133 advances the process to S1700. When the connection state of the terminal 140 is not changed (NO in S1300), the space time coordinator 133 advances the process to S1800, which is described below.

In S1700, the space time coordinator 133 acquires the terminal identification information and the beam number, which have been input, as the connection information. After that, the space time coordinator 133 corrects the coordinate table 210 (see FIG. 3) in accordance with the acquired connection information and advances the process to S1400 described above.

In S1800, the space time coordinator 133 determines whether or not any of the terminals 140 is decreased in quality of the communication with the radio communication device 130 is present. Such decrease in communication quality is caused when, for example, the terminal 140 is moved or a communication path is temporarily blocked by an object. The space time coordinator 133 performs such determination in accordance with, for example, whether or not the level of the communication quality indicated by the quality information input from the low-level MAC layer processor 132 is equal to or less than the predetermined threshold.

When the terminal 140 decreased in communication quality is present (YES in S1800), the space time coordinator 133 advances the process to S1900. When the terminal 140 decreased in communication quality is not present (NO in S1800), the space time coordinator 133 advances the process to S1600 described above.

In S1900, the space time coordinator 133 determines whether or not to switch the connection destination of the terminal 140 decreased in communication quality in accordance with the interference information, that is, the first to third interference levels 216 to 218 in the coordinate table 210 (see FIG. 3).

When it is determined to switch the connection destination, the space time coordinator 133 causes the low-level MAC layer processor 132 to switch the PHY layer processor 131, which serves as the connection destination of the terminal 140 concerned. After that, the space time coordinator 133 corrects the coordinate table 210 in accordance with the content of the switching and advances the process to S1400 described above.

For example, it is assumed that while the communication quality of the second terminal 140₂ connected to the first PHY layer processor 131a decreases, in any of the beam patterns of the second PHY layer processor 131b, the radio signal from the second terminal 140₂ is received with high reception strength.

In this case, the space time coordinator 133 determines to switch the connection destination of the second terminal 140₂ to the second PHY layer processor 131b. At the time, the space time coordinator 133 may instruct the second low-level MAC layer processor 132b to use the beam pattern high in reception strength for the communication with the second terminal 140₂.

When instructed to end the process (YES in S1600), the space time coordinator 133 ends the process as a series.

The space time coordinator 133 may cause the inter-MAC synchronization SLS to be performed periodically without depending on the presence or absence of new connection of the terminal 140, the presence or absence of change in the connection state, or the quality of the communication with each terminal 140 and may update the coordinate table 210.

Through the above-described operation, the radio communication device 130 can perform the scheduling of the beam forming in accordance with what beam pattern is used for the communication with each terminal 140, and which combination of the beam patterns causes communication interference. Accordingly, the radio communication device 130 may multiplex the communication with the terminal 140 not only by time division but also by space division.

### Distribution and Scheduling of Data

Described below is an example of the distribution of the data directed to each terminal 140 and the scheduling of the beam forming.

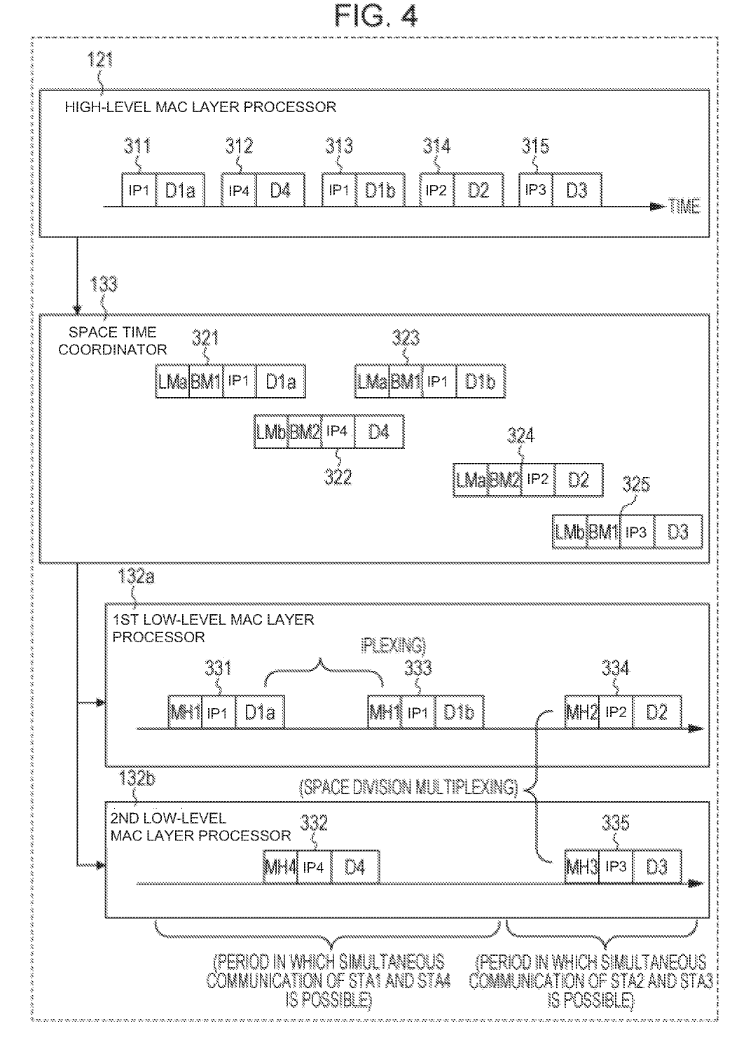

FIG. 4 illustrates how the distribution of data and the scheduling of the beam forming are performed by the space time coordinator 133 as an example.

In FIG. 4, the horizontal axis indicates time and the vertical axis indicates the direction of the flow of the data directed from the high-level MAC layer processor 121 to each low-level MAC layer processor 132.

For example, as illustrated in the upper portion of FIG. 4, the high-level MAC layer processor 121 receives first to fifth IP packets 311 to 315 from the external network.

The destinations of the first to fifth IP packets 311 to 315 are, respectively, the first terminal 140₁ (IP1), the fourth terminal 140₄ (IP4), the first terminal 140₁ (IP1), the second terminal 140₂ (IP2), and the third terminal 140₃ (IP3). The high-level MAC layer processor 121 distributes the first to fifth IP packets 311 to 315 to the radio communication device 130 and transfers the first to fifth IP packets 311 to 315 to the space time coordinator 133 in this order.

The space time coordinator 133 acquires the low-level MAC addresses and the beam numbers corresponding to the respective destination IP addresses of the received first to fifth IP packets 311 to 315 from the coordinate table 210 (see FIG. 3). After that, as illustrated in the middle portion of FIG. 4, the space time coordinator 133 adds the low-level MAC address and the beam number to each of the first to fifth IP packets 311 to 315 and generates first to fifth coordinate packets 321 to 325.

Each destination of the first, third, and fourth coordinate packets 321, 323, and 324 is the first low-level MAC layer processor 132a (LMa). Each destination of the second and fifth coordinate packets 322 and 325 is the second low-level MAC layer processor 132b (LMb). The space time coordinator 133 outputs the first, third, and fourth coordinate packets 321, 323, and 324 to the first low-level MAC layer processor 132a, and outputs the second and fifth coordinate packets 322 and 325 to the second low-level MAC layer processor 132b.

After that, as illustrated on the upper side in the lower portion of FIG. 4, the first low-level MAC layer processor 132a sequentially generates first, third, and fourth low-level MAC packets 331, 333, and 334 based on the input first, third, and fourth coordinate packets 321, 323, and 324.

More specifically, the first low-level MAC layer processor 132a replaces the low-level MAC addresses and the beam numbers of the first, third, and fourth coordinate packets 321, 323, and 324 with the terminal MAC header addresses. After that, the first low-level MAC layer processor 132a transmits each of the first, third, and fourth low-level MAC packets 331, 333, and 334 from the first PHY layer processor 131a using the beam patterns corresponding to the replaced beam numbers.

Further, as illustrated on the lower side in the lower portion of FIG. 4, the second low-level MAC layer processor 132b sequentially generates second and fifth low-level MAC packets 332 and 335 based on the input second and fifth coordinate packets 322 and 325.

More specifically, the second low-level MAC layer processor 132b replaces the low-level MAC addresses and the beam numbers of the second and fifth low-level MAC packets 332 and 335 with the terminal MAC header addresses. After that, the second low-level MAC layer processor 132b transmits each of the second and fifth low-level MAC packets 332 and 335 from the second PHY layer processor 131b using the beam patterns corresponding to the replaced beam numbers.

As described above, the space time coordinator 133 controls a timing at which each low-level MAC layer processor 132 performs communication by directing a beam to each terminal 140 using the PHY layer processor 131.

For example, it is assumed that the space time coordinator 133 determines that in the combination of the second beam pattern 160₂ and the third beam pattern 160₃, no communication interference is occurring, or even when communication interference is occurring, the level of the communication interference is sufficiently low. In this case, as illustrated in the lower portion of FIG. 4, the space time coordinator 133 determines to, for example, perform communication with the second terminal 140₂ (STA2) and communication with the third terminal 140₃ (STA3) at the same time by space division multiplexing.

The space time coordinator 133 may couple a plurality of packets whose destinations are the identical terminal 140, such as the first and third coordinate packets 321 and 323, and perform the scheduling so as to reduce the overhead, such as the preamble.

### Advantages of Present Embodiment

As described above, the radio communication device 130 according to the present embodiment acquires the connection information and the interference information and performs the scheduling of the beam forming of the plurality of directional communicators in accordance with the acquired information. The connection information as used herein is information on each directional communicator, which indicates the terminal 140 to which the directional communicator concerned is connected, and the beam pattern used for the communication with the terminal 140 concerned. The interference information as used herein is information on each combination of the plurality of beam patterns among the plurality of directional communicators, which indicates whether or not communication interference is caused in the combination concerned.

The radio communication device 130 described above can increase opportunities of simultaneous communication with the plurality of terminals 140 while reducing the overhead at the time of handover even when the millimeter wave communication is employed, and enables accommodation or connection of more radio terminals, that is, increase in system capacity.

According to the present embodiment, the radio communication device 130 includes the space time coordinator 133, which distributes data to the plurality of directional communicators between the high-level MAC layer and the low-level MAC layers. Since the radio communication device 130 can thus process the handover among the plurality of directional communicators at high speed, in the millimeter wave communication that needs following of the positions of the terminals 140, smooth handover can be achieved.

Since in a conventional radio communication scheme for a microwave band, such as the wireless LAN, radio waves are nondirectional and attenuation in space is relatively small, the range where the radio waves reach (the cell) is wide and the handover process is performed with sufficient time. In the millimeter wave communication, however, as described above, since the communication with each terminal 140 is performed through beam forming, it is desired to perform the handover process as promptly as possible.

In this regard, the radio communication device 130 performs the data distribution while coming closer to the low-level MAC layer and thus, compared to a case where the distribution is performed on the side of the AP controller 120, the handover process can be performed in shorter time and still more terminals 140 can be accommodated or connected.

### Variation of Present Embodiment

Although the number of the directional communicators included in the radio communication device 130 is two in the above-described embodiment, the number is not limited to two. The radio communication device 130 may include three or more directional communicators and perform the distribution of data or the scheduling of the beam forming with the three or more directional communicators.

When three or more directional communicators are included, for the terminal 140 decreased in reception quality level, the radio communication device 130 may determine a directional communicator that forms a beam pattern highest in level of the interference from the terminal concerned, that is, in level of the reception from the terminal concerned among from the directional communicators other than the directional communicator currently connected, and may determine the determined directional communicator as the switching destination of the connection of the terminal 140 concerned.

Further, the specific contents of various kinds of information including the connection information and the interference information are not limited to the above-described examples. For example, when the combination of the beam patterns that causes interference is clear in advance, the radio communication device 130 may acquire the information indicating such a combination as the interference information.

The millimeter wave communication employed for the radio communication device 130 may be based on a standard other than the IEEE 802.11ad standard. For example, the millimeter wave communication employed for the radio communication device 130 may be another kind of radio communication with directivity, such as the radio communication based on WiGig, IEEE 802.15.3c, wireless high definition (HD), or ECMA-387. Similarly, the beam forming protocol is not limited to the above-described SLS processes.

Part of the configuration of the radio communication device 130 may be arranged so as to by physically separated from another part of the configuration of the radio communication device 130. For example, the space time coordinator 133 may be arranged in the AP controller 120. In this case, each part needs to include a communication circuit for performing mutual communication.

Although various aspects of the embodiment are described above with reference to the drawings, it is needless to mention that the present disclosure is not limited to such examples. A person skilled in the art may arrive at variations or modifications within the scope recited in the claims, and the variations or modifications should be understood as belonging in the technical scope of the present disclosure as a matter of course. Also, the constituents of the above-described embodiment may be combined as desired within the scope not departing from the spirit of the disclosure.

The present disclosure may be configured using hardware or can be implemented with software.

Each of the functional blocks used above in describing the embodiment is typically implemented as large-scale integration (LSI), which is an integrated circuit (IC). The ICs may be made individually as single chips, or may be made as a single chip so as to include part or all of the functional blocks. Depending on the degree of the integration, the above-mentioned LSI may be also referred to as an IC, system LSI, super LSI, or ultra LSI.

The circuit integration method is not limited to the LSI, and a dedicated circuit or a general-purpose processor may be used for the implementation. A field-programmable gate array (FPGA), which is programmable, or a reconfigurable processor, which is capable of reconfiguring the connection and setting of circuit cells inside the LSI, may be utilized after manufacturing the LSI.

Moreover, when other techniques for the circuit integration that replaces the LSI are brought by advance of semiconductor techniques or other derivative techniques, the functional blocks may be integrated by such techniques. Application of biotechnology is possible, for example.

The present disclosure can be expressed as a communication control method performed in a radio communication device. Further, the present disclosure can be also expressed as a program for causing the communication control method to be operated with a computer. In addition, the present disclosure can be also expressed as a recording medium where the program is recorded so as to be readable by a computer. That is, the present disclosure may be expressed in any category of devices, methods, programs, and recording media.

### Outline of Present Disclosure

A radio communication device according to the present disclosure includes: a plurality of directional communicating circuitry which, in operation, each become connected to one or more radio terminals through beam forming and perform radio communication; and space time coordinating circuitry which, in operation, performs controlling of the beam forming of each of the plurality of directional communicating circuitry in accordance with connection information on the connected one or more radio terminals and interference information on interference among the plurality of directional communicating circuitry, wherein the connection information includes information on the connected one or more radio terminals and information on a beam pattern used for communication with the connected one or more radio terminals and is acquired by the space time coordinator, the interference information includes information that, for each of combinations of a plurality of beam patterns among the plurality of directional communicating circuitry, indicates whether or not communication interference occurs in the combination.

In the above-described radio communication device, in accordance with the connection information, the space time coordinating circuitry further causes data transfer between each of another communication layer to which the radio communication device is connected and the plurality of directional communicating circuitry.

In the above-described radio communication device, the plurality of beam patterns may include beam patterns different in beam direction. In the above-described radio communication device, in a case that a combination of desired beam patterns that causes no communication interference is present among the combinations of the plurality of beam patterns, the space time coordinating circuitry selects the combination of the desired beam patterns, and in a case that a combination of undesired beam patterns that causes communication interference is present among the combinations of the plurality of beam patterns, the space time coordinating circuitry selects a combination of beam patterns other than the combination of the undesired beam patterns.

In the above-described radio communication device, adjacent communication areas of the respective directional communicators may overlap each other at least partially.

In the above-described radio communication device, the space time coordinating circuitry further acquires quality information that indicates one or more of reception quality of a radio signal transmitted from each of the plurality of directional communicating circuitry at each of the one or more radio terminals in each of the plurality of beam patterns, and reception quality of a radio signal transmitted from each of the connected one or more radio terminals at each of the plurality of directional communicating circuitry in each of the plurality of beam patterns, and the space time coordinating circuitry detects the interference information from the acquired quality information.

In the above-described radio communication device, each of the plurality of directional communicating circuitry acquires the quality information in beam forming training for the one or more radio terminals, and the space time coordinating circuitry performs the scheduling of the beam forming or the data transfer using the information on each of the connected directional communicating circuitry, the information on the beam pattern used for communication with the connected one or more radio terminals, identification information on each of the one or more radio terminals, and information on the reception quality regarding the beam pattern not used for communication with the connected one or more radio terminals.

In the above-described radio communication device, the space time coordinating circuitry switches the beam pattern of each of the plurality of directional communicating circuitry in accordance with the quality information and changes a connection destination of the one or more radio terminals connected to first directional communicating circuitry included in the plurality of directional communicating circuitry to second directional communicating circuitry included in the plurality of directional communicating circuitry.

In the above-described radio communication device, the space time coordinating circuitry switches the beam pattern of each of the plurality of directional communicating circuitry in accordance with the interference information and changes a connection destination of the one or more radio terminals connected to first directional communicating circuitry included in the plurality of directional communicating circuitry to second directional communicating circuitry included in the plurality of directional communicating circuitry.

In the above-described radio communication device, each of the plurality of directional communicating circuitry includes: physical layer processing circuitry which, in operation, performs the beam forming; and low-level medium access control (MAC) layer processing circuitry which, in operation, performs transmission and reception of data with the one or more radio terminals using the physical layer processing circuitry, the other communication layer includes controlling circuitry which, in operation, performs a process of a high-level MAC layer, and the space time coordinating circuitry performs transfer of data between the controlling circuitry and the low-level MAC layer processing circuitry, the transferred data being transmitted to or from the one or more radio terminals.

A communication control method according to the present disclosure is a communication control method of a radio communication device that includes a plurality of directional communicating circuitry, the method including: acquiring connection information on one or more radio terminals connected to each of the plurality of directional communicating circuitry, using by a plurality of directional communicating circuitry; and performing controlling of beam forming in accordance with the connection information and interference information on interference among the plurality of directional communicating circuitry, using by space time coordinating circuitry, wherein the connection information includes information on the connected one or more radio terminals and information on a beam pattern used for communication with the connected one or more radio terminals and is acquired by a space time coordinating circuitry for each of the plurality of directional communicating circuitry, the interference information includes information that, for each of combinations of a plurality of beam patterns among the plurality of directional communicating circuitry, indicates whether or not communication interference occurs in the combination.

Even when the millimeter wave communication is employed, the present disclosure is useful as a radio communication device that enables accommodation or connection of more radio terminals and a communication control method.

What is claimed is:

1. A radio communication device comprising:
a plurality of directional communicating circuitry which, in operation, each become connected to one or more radio terminals through beam forming and perform radio communication; and
space time coordinating circuitry which, in operation, performs controlling of the beam forming of each of the plurality of directional communicating circuitry in accordance with connection information on the connected one or more radio terminals and interference information on interference among the plurality of directional communicating circuitry, wherein
the connection information includes information on the connected one or more radio terminals and information on a beam pattern used for communication with the connected one or more radio terminals and is acquired by the space time coordinator,
the interference information includes information that, for each of combinations of a plurality of beam patterns among the plurality of directional communicating circuitry, indicates whether or not communication interference occurs in the combination.

2. The radio communication device according to claim 1, wherein
in accordance with the connection information, the space time coordinating circuitry further causes data transfer between each of another communication layer to which the radio communication device is connected and the plurality of directional communicating circuitry.

3. The radio communication device according to claim 2, wherein
the plurality of beam patterns include beam patterns different in beam direction.

4. The radio communication device according to claim 3, wherein
in a case that a combination of desired beam patterns that causes no communication interference is present among the combinations of the plurality of beam patterns, the space time coordinating circuitry selects the combination of the desired beam patterns, and
in a case that a combination of undesired beam patterns that causes communication interference is present among the combinations of the plurality of beam patterns, the space time coordinating circuitry selects a combination of beam patterns other than the combination of the undesired beam patterns.

5. The radio communication device according to claim 3, wherein
adjacent communication areas of the respective directional communicators overlap each other at least partially.

6. The radio communication device according to claim 3, wherein
the space time coordinating circuitry further acquires quality information that indicates one or more of reception quality of a radio signal transmitted from each of the plurality of directional communicating circuitry at each of the one or more radio terminals in each of the plurality of beam patterns, and reception quality of a radio signal transmitted from each of the connected one or more radio terminals at each of the plurality of directional communicating circuitry in each of the plurality of beam patterns, and
the space time coordinating circuitry detects the interference information from the acquired quality information.

7. The radio communication device according to claim 6, wherein
each of the plurality of directional communicating circuitry acquires the quality information in beam forming training for the one or more radio terminals, and
the space time coordinating circuitry performs the scheduling of the beam forming or the data transfer using the information on each of the connected directional communicating circuitry, the information on the beam pattern used for communication with the connected one or more radio terminals, identification information on each of the one or more radio terminals, and information on the reception quality regarding the beam pattern not used for communication with the connected one or more radio terminals.

8. The radio communication device according to claim 6, wherein
the space time coordinating circuitry switches the beam pattern of each of the plurality of directional communicating circuitry in accordance with the quality information and changes a connection destination of the one or more radio terminals connected to first directional communicating circuitry included in the plurality of directional communicating circuitry to second directional communicating circuitry included in the plurality of directional communicating circuitry.

9. The radio communication device according to claim 6, wherein
the space time coordinating circuitry switches the beam pattern of each of the plurality of directional communicating circuitry in accordance with the interference information and changes a connection destination of the one or more radio terminals connected to first directional communicating circuitry included in the plurality of directional communicating circuitry to second directional communicating circuitry included in the plurality of directional communicating circuitry.

10. The radio communication device according to claim 2, wherein
each of the plurality of directional communicating circuitry includes:
physical layer processing circuitry which, in operation, performs the beam forming; and
low-level medium access control (MAC) layer processing circuitry which, in operation, performs transmission and reception of data with the one or more radio terminals using the physical layer processing circuitry,
the other communication layer includes controlling circuitry which, in operation, performs a process of a high-level MAC layer, and
the space time coordinating circuitry performs transfer of data between the controlling circuitry and the low-level MAC layer processing circuitry, the transferred data being transmitted to or from the one or more radio terminals.

11. A communication control method of a radio communication device that includes a plurality of directional communicating circuitry, the method comprising:
acquiring connection information on one or more radio terminals connected to each of the plurality of directional communicating circuitry, using by a plurality of directional communicating circuitry; and
performing controlling of beam forming in accordance with the connection information and interference information on interference among the plurality of directional communicating circuitry, using by space time coordinating circuitry, wherein
the connection information includes information on the connected one or more radio terminals and information on a beam pattern used for communication with the connected one or more radio terminals and is acquired by a space time coordinating circuitry for each of the plurality of directional communicating circuitry,
the interference information includes information that, for each of combinations of a plurality of beam patterns among the plurality of directional communicating circuitry, indicates whether or not communication interference occurs in the combination.
